(19) United States
(12) Patent Application Publication
(10) Pub. No.: US 2007/0140504 A1
(43) Pub. Date: Jun. 21, 2007

(54) Method and apparatus for masking acoustic keyboard emanations

(76) Inventors: Guy L. Tribble, Hillsborough, CA (US); Richard F. Murphy, Boulder Creek, CA (US)

Correspondence Address: APPLE COMPUTER, INC.;c/o PARK, VAUGHAN & FLEMING LLP, 2820 FIFTH STREET, DAVIS, CA, 95618-7759, US

(21) Appl. No.: 11/303,760

(22) Filed: Dec. 15, 2005

(51) Int. Cl. H04R 3/02

(52) U.S. Cl. 381/73.1

(57) ABSTRACT

One embodiment of the present invention provides a system that masks acoustic emanations from a keyboard. Upon receiving a signal indicating that a key on the keyboard has been pressed and/or released, the system generates a masking signal, and then outputs the masking signal to one or more audio transducers located in proximity to the keyboard, thereby masking acoustic emanations caused by the key being pressed and/or released.

### BACKGROUND

1. Field of the Invention

The present invention relates to techniques for providing computer security. More specifically, the present invention relates to a method and an apparatus for masking acoustic emanations from a keyboard to prevent an eavesdropper from recognizing the acoustic signatures of individual keystrokes.

2. Related Art

Many types of sensitive data, such as passwords, are routinely entered into computer keyboards. This type of data entry has become significantly less secure because of recently-developed signal-processing techniques, which can be used to determine what information is typed into a keyboard. These techniques operate by recording the sound produced by the keyboard and then processing the sound to determine which keys were pressed. (See L. Zhuang, F. Zhou and J. D. Tygar, “Keyboard Acoustic Emanations Revisited,” Proceedings of the 12^{th} ACM Conference on Computer and Communications Security, November 2005.) Consequently, it presently possible for an eavesdropper to gather acoustic emanations from a keyboard from a distance using a long-range “shotgun” microphone, and to then process these acoustic emanations to reveal what was typed into the keyboard. This could result in a serious breach of computer system security if a critical password is compromised.

This type of eavesdropping can be somewhat mitigated by providing sound-insulation any room in which typing takes place to prevent an eavesdropper from gathering an audio signal of a stream of keystrokes. However, it is quite expensive and cumbersome to provide such sound-insulation. Furthermore, portable computing devices, such as laptops, are often used in public locations, where sound insulation is not available.

It is also possible to mask the sound of the typing by placing a white-noise source in the vicinity of the typing. However, such a white noise source is likely to be annoying and impractical in most locations.

Hence, what is needed is a method and an apparatus for preventing eavesdroppers from gathering acoustic emanations from a keyboard and then analyzing these emanations to determine what was typed into the keyboard.

### SUMMARY

One embodiment of the present invention provides a system that masks acoustic emanations from a keyboard. Upon receiving a signal indicating that a key on the keyboard has been pressed and/or released, the system generates a masking signal, and then outputs the masking signal to one or more audio transducers located in proximity to the keyboard, thereby masking acoustic emanations caused by the key being pressed and/or released.

In a variation on this embodiment, generating the masking signal involves generating a randomized signal so that a different masking signal is generated each time a specific key is pressed and/or released. This randomized signal can be generated by: (1) obtaining an acoustic signal caused by a given key being pressed and/or released to act as a template for the masking signal, and (2) randomly modifying the template to produce the masking signal. Alternatively, the randomized masking signal can be generated by: (1) obtaining a pulse of substantially constant amplitude to act as a template for the masking signal, and then (2) randomly modifying the template to produce the masking signal.

In a variation on this embodiment, generating the masking signal involves generating a signal which is characteristic of a different key being pressed and/or released, instead of the actual key that was pressed and/or released. In this way, an eavesdropper may be misled into determining that the different key was pressed and/or released.

In a variation on this embodiment, the one or more audio transducers include multiple speakers located in proximity to the keyboard. In this embodiment, generating the masking signal involves generating signals for the multiple speakers which spatially position the resulting sound so that the resulting sound appears to emanate from the vicinity of the key that was pressed and/or released.

In a variation on this embodiment, the system enables (or disables) outputting of the masking signal based on a user-selectable preference.

In a variation on this embodiment, the masking signal is generated by a computing device which receives input from the keyboard, or alternatively is generated by a computing engine which is integrated into the keyboard.

In a variation on this embodiment, the keyboard can include any type of data entry device or mechanism which has multiple keys or buttons.

### BRIEF DESCRIPTION OF THE FIGURES

FIG. 1 illustrates an exemplary computing device with a keyboard in accordance with an embodiment of the present invention.

FIG. 2 presents a flow chart illustrating the process of masking the sound of a key being pressed and/or released in accordance with an embodiment of the present invention.

FIG. 3 illustrates exemplary masking waveforms in accordance with an embodiment of the present invention.

Table 1 presents exemplary code that generates and outputs a masking signal in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs).

Computing Device with Keyboard

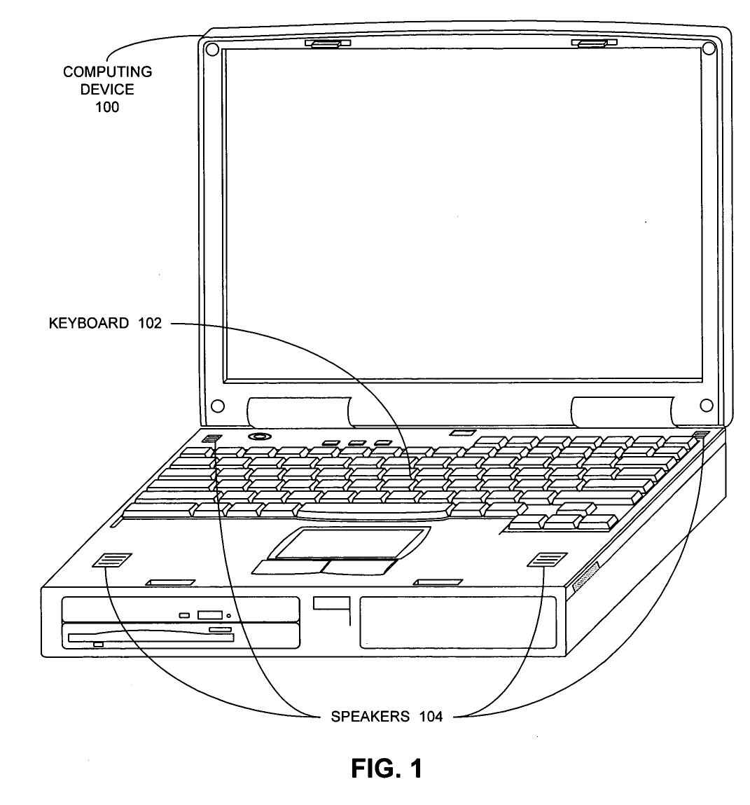

FIG. 1 illustrates an exemplary computing device 100 with a keyboard 102 in accordance with an embodiment of the present invention. The exemplary computing device 100 illustrated in FIG. 1 is a laptop computer, which includes a keyboard 102 and speakers 104. However, in general, the present invention can be applied to any type of computing device or computer system that can receive input from a keyboard or a keypad. This includes, but is not limited to, a computing device or computing system based on a microprocessor, a mainframe computer, a digital signal processor, a portable computing device, a personal organizer, a device controller, and a computational engine within an appliance.

Keyboard 102 can include any type of data entry device or mechanism which has multiple keys or buttons, such as a keyboard or a keypad.

Speakers 104 can include any type of acoustic transducer that can produce acoustic signals, which can be used to mask acoustic emanations from keyboard 102.

Computing device 100 can include any type of computational engine, such as a microprocessor, which can perform the computational operations which are described below.

Process of Masking the Sound of a Key Being Pressed and/or Released

One embodiment of the present invention uses an audio transducer, such as a speaker, to produce masking sounds, which are synchronized with corresponding keystrokes on a keyboard. These masking sounds can be randomized to decrease an eavesdropper's ability to differentiate individual keystrokes by analyzing their acoustic signatures. Moreover, producing a masking sound which is coincident with a keystroke provides an ergonomic advantage in some situations by providing audible feedback for a keystroke.

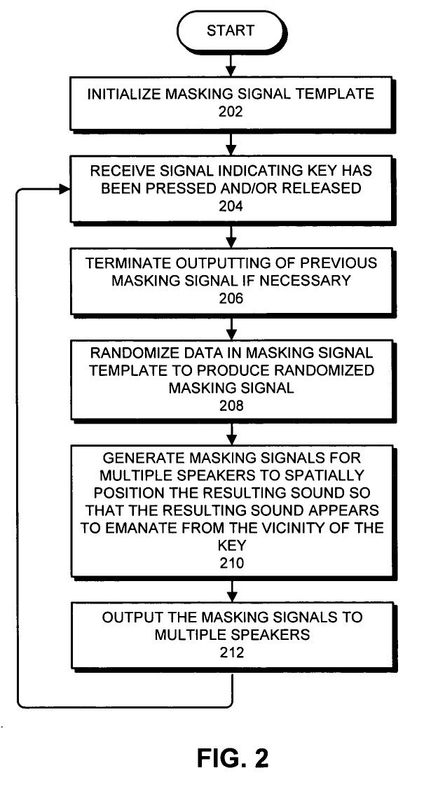

More specifically, FIG. 2 presents a flow chart illustrating the process of masking the sound of a key being pressed and/or released in accordance with an embodiment of the present invention. This process starts by initializing a “masking template” which contains a waveform, such as an audio signature for a specific keystroke and/or key-release (step 202). For example, this masking template can be obtained by digitizing the sound of the specific keystroke and/or key-release.

Next, the system receives a signal indicating that a specific key has been pressed and/or released (step 204). It is well-known in the art how to receive such a signal within a computer system, so this step will not be described any further in this specification.

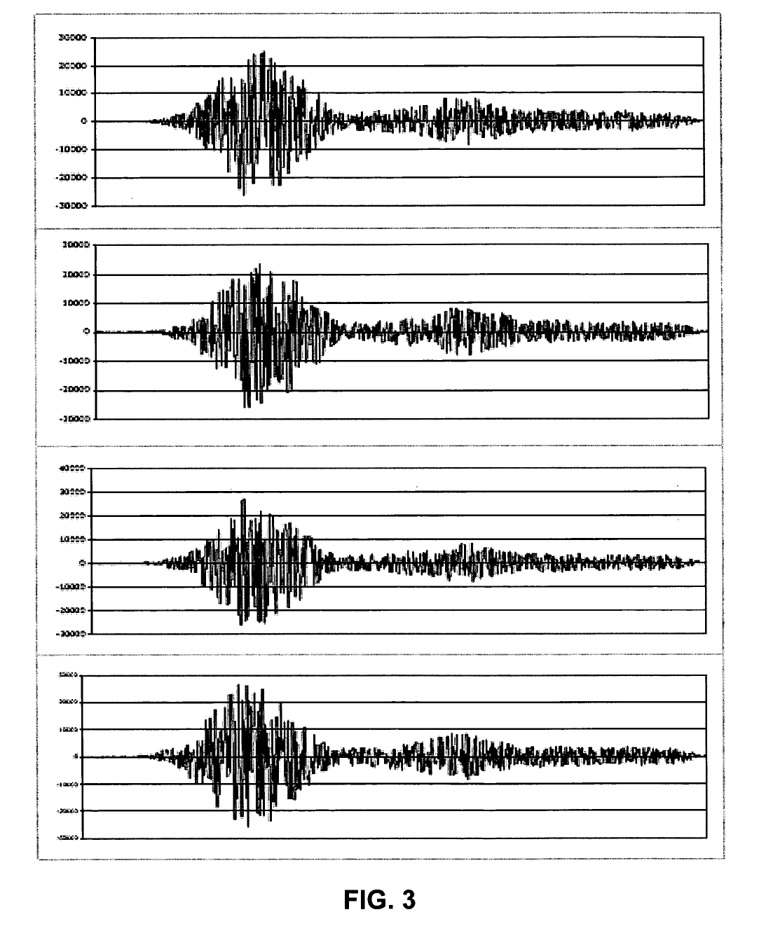

Upon receiving this signal, the system terminates the output of a preceding masking signal, if necessary (step 206). The system also uses a random number generator to randomize the masking signal to produce a “randomized masking signal” (step 208). (A number of exemplary randomized masking signal waveforms are illustrated in FIG. 3.)

If there are multiple speakers, the system can also generate masking signals for the multiple speakers so that the resulting sound appears to emanate from the vicinity of the key that was pressed and/or released (step 210). This “spatial-positioning operation” can be performed using any one of a number of well-known techniques for spatially-positioning sounds in stereo or multi-channel audio systems, so that the sounds appear to emanate from specific locations.

Finally, the system outputs the generated masking sounds to the speakers 104, which are located in the vicinity of keyboard 102 (step 212).

An exemplary section of computer code which performs these masking operations appears in Table 1 below.

TABLE 1
#import “MyApplication.h”
// MyApplication.m
// NewSound
@implementation MyApplication
- (void)awakeFromNib {

int i;
// This is the rough envelope for a key sound.
unsigned char template[DATA_LENGTH] = \

{82, 73, 70, 70, 130, 7, 0, 0, 87, 65, \
// Additional waveform data omitted }
for (i=0; i<DATA_LENGTH; i++)

initData[i] = staticTemplate[i] = template[i];

// Initialize mySsound
mySound = [NSSound soundNamed:@″keysound0″];

}
- (void)sendEvent:(NSEvent *)theEvent {

int j;
short val;
double max = 2147483647.0;
if (([theEvent type] == NSKeyDown) \

|| ([theEvent type] == NSKeyUp)) {

// multiply template data by random noise
for (j=44; j<DATA_LENGTH; j+=2) {

// data is stored ″little endian″
val = staticTemplate [j] +
(staticTemplate[j+1]<<8);
val = 2.0*((random( )/max)−0.5)*val;
initData[j] = val & 255;
initData[j+1] = (val >> 8) & 255;

}
[mySound stop]; // make sure we don't
overlap sounds
[mySound initWithData:[NSData
dataWithBytes:&initData[0]

length:DATA_LENGTH]];

[mySound play];

}
[super sendEvent:theEvent];

}

@end

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for masking acoustic emanations from a keyboard, comprising:
receiving a signal indicating that a key on the keyboard has been pressed and/or released; and
in response to the signal,
generating a masking signal, and
outputting the masking signal to one or more audio transducers located in proximity to the keyboard thereby masking acoustic emanations caused by the key being pressed and/or released.

2. The method of claim 1, wherein generating the masking signal involves generating a randomized signal so that a different masking signal is generated each time a specific key is pressed and/or released.

3. The method of claim 2, wherein generating the randomized signal involves:
obtaining an acoustic signal caused by a given key being pressed and/or released; and
randomly modifying the acoustic signal to produce the masking signal.

4. The method of claim 2, wherein generating the randomized signal involves:
obtaining an acoustic signal which comprises a pulse of substantially constant amplitude; and
randomly modifying the acoustic signal to produce the masking signal.

5. The method of claim 1, wherein generating the masking signal involves generating a signal which is characteristic of a different key being pressed and/or released instead of the actual key that was pressed and/or released, whereby an eavesdropper will be misled into determining that the different key was pressed and/or released.

6. The method of claim 1,
wherein the one or more audio transducers includes multiple speakers located in proximity to the keyboard; and
wherein generating the masking signal involves generating masking signals for the multiple speakers which spatially position the resulting sound so that the resulting sound appears to emanate from the vicinity of the key that was pressed and/or released.

7. The method of claim 1, further comprising enabling or disabling outputting of the masking signal based on a user-selectable preference.

8. The method of claim 1, wherein generating the masking signal involves:
generating the masking signal within a computing device which receives input from the keyboard; or
generating the masking signal within a computing engine which is integrated into the keyboard.

9. The method of claim 1, wherein the keyboard can include any type of data entry device or mechanism which has multiple keys or buttons.

10. A method for masking acoustic emanations from a keyboard, comprising:
receiving a signal indicating that a key on the keyboard has been pressed and/or released; and
in response to the signal,
generating masking signals for multiple speakers located in proximity to the keyboard, and
outputting the masking signal to the multiple speakers thereby masking acoustic emanations caused by the key being pressed and/or released,
wherein the masking signals are generated to spatially position the resulting sound so that the resulting sound appears to emanate from the vicinity of the key that was pressed and/or released.

11. The method of claim 10, wherein generating the masking signal involves generating a randomized signal so that a different masking signal is generated each time a specific key is pressed and/or released.

12. The method of claim 10, wherein generating the masking signal involves generating a signal which is characteristic of a different key being pressed and/or released instead of the actual key that was pressed and/or released, whereby an eavesdropper will be misled into determining that the different key was pressed and/or released.

13. An apparatus which is configured to mask acoustic emanations from a keyboard associated with the computing device, comprising:
a computing engine;
an input to the computing engine configured receiving a signal indicating that a key on the keyboard has been pressed and/or released; and
wherein in response to the signal, the computing engine is configured to
generate a masking signal, and to
output the masking signal to one or more speakers located in proximity to the keyboard thereby masking acoustic emanations caused by the key being pressed and/or released.

14. The apparatus of claim 13, wherein while generating the masking signal the computing engine is configured to generate a randomized signal so that a different masking signal is generated each time a specific key is pressed and/or released.

15. The apparatus of claim 13, wherein while generating the masking signal the computing engine is configured to generate a signal which is characteristic of a different key being pressed and/or released instead of the actual key that was pressed and/or released, whereby an eavesdropper will be misled into determining that the different key was pressed and/or released.

16. The apparatus of claim 13,
wherein the one or more audio transducers includes multiple speakers located in proximity to the keyboard; and
wherein while generating the masking signal the computing engine is configured to generate masking signals for the multiple speakers which spatially position the resulting sound so that the resulting sound appears to emanate from the vicinity of the key that was pressed and/or released.

17. The apparatus of claim 13, wherein the computing engine includes an enabling mechanism which is configured to enable or disable outputting of the masking signal based on a user-selectable preference.

18. The apparatus of claim 13, wherein the computing engine is part of a computing device which receives input from the keyboard.

19. The apparatus of claim 13, wherein the computing engine is integrated into the keyboard.

20. A computer-readable storage medium storing instructions that when executed by a computer cause the computer to perform a method for masking acoustic emanations from a keyboard, the method comprising:
receiving a signal indicating that a key on the keyboard has been pressed and/or released; and
in response to the signal,
generating a masking signal, and
outputting the masking signal to one or more audio transducers located in proximity to the keyboard thereby masking acoustic emanations caused by the key being pressed and/or released.

21. The computer-readable storage medium of claim 20, wherein generating the masking signal involves generating a randomized signal so that a different masking signal is generated each time a specific key is pressed and/or released.

22. The computer-readable storage medium of claim 20, wherein generating the masking signal involves generating a signal which is characteristic of a different key being pressed and/or released instead of the actual key that was pressed and/or released, whereby an eavesdropper will be misled into determining that the different key was pressed and/or released.

23. The computer-readable storage medium of claim 20,
wherein the one or more audio transducers includes multiple speakers located in proximity to the keyboard; and
wherein generating the masking signal involves generating masking signals for the multiple speakers which spatially position the resulting sound so that the resulting sound appears to emanate from the vicinity of the key that was pressed and/or released.
